(19) United States
(12) Patent Application Publication
(10) Pub. No.: US 2006/0154927 A1
(43) Pub. Date: Jul. 13, 2006

(54) Fungicidal mixtures for combating rice pathogens

(76) Inventors: Jordi Tormo I Blasco, Laudenbach (DE); Thomas Grote, Wachenheim (DE); Maria Scherer, Godramstein (DE); Reinhart Stierl, Freinsheim (DE); Siegfried Strathmann, Limburgerhof (DE); Ulrich Schofl, Bruhl (DE)

Correspondence Address: BIRCH STEWART KOLASCH & BIRCH, PO BOX 747, FALLS CHURCH, VA, 22040-0747, US

(21) Appl. No.: 10/561,188

(22) PCT Filed: Jun. 19, 2004
(86) PCT No.: PCT/EP04/06649

§ 371 Date: Dec. 19, 2005

(30) Foreign Application Priority Data
Jun. 30, 2003 (DE) 103-29-554.2
Jul. 16, 2003 (DE) 103-32-428.3
Apr. 22, 2004 (DE) 102004-020-212.5

(51) Int. Cl. A01N 43/90

(52) U.S. Cl. 514/237.5; 514/259.31

(57) ABSTRACT

Fungicidal mixtures for controlling rice pathogens, comprising, as active components,
1) the triazolopyrimidine derivative of the formula I, 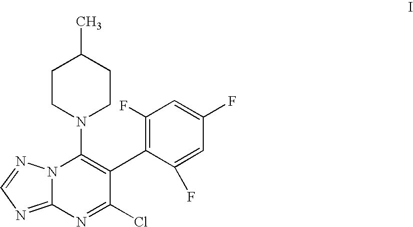 and
2) an acryloylmorpholide of the formula II, 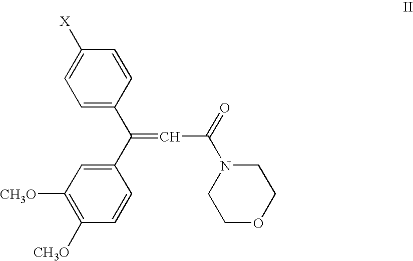 in which X is chlorine or fluorine, in a synergistically effective amount, methods for controlling rice pathogens using mixtures of the compound I with the compounds II, the use of the compound I and the compounds II for preparing such mixtures and compositions comprising these mixtures are described.

The present invention relates to fungicidal mixtures for controlling rice pathogens, comprising as active components
1) the triazolopyrimidine derivative of the formula I, 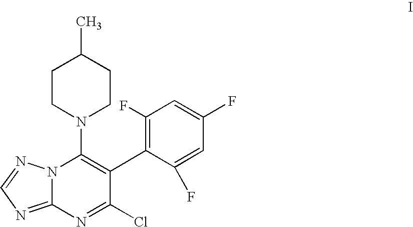
and
2) an acryloylmorpholide of the formula II, 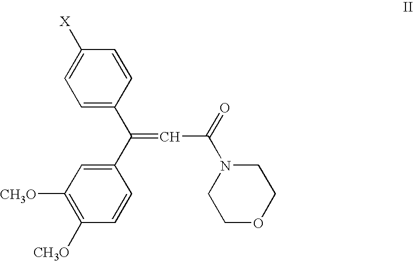
in which X is chlorine or fluorine
in a synergistically effective amount.

Moreover, the invention relates to a method for controlling rice pathogens using mixtures of the compound I with the compounds II and to the use of the compound I with the compounds II for preparing such mixtures and compositions comprising these mixtures.

The compound I, 5-chloro-7-(4-methylpiperidin-1-yl)-6-(2,4,6-trifluorophenyl)-[1,2,4]triazolo[1,5-a]pyrimidine, its preparation and its action against harmful fungi are known from the literature (WO 98/46607).

The compounds II, their preparation and their action against harmful fungi are likewise known from the literature (EP-A 120 321). The compound II in which X is chlorine, 3-(4-chlorophenyl)-3-(3,4-dimethoxyphenyl)-1-morpholin-4-ylpropenone (IIa), is, under the common name “dimethomorph”, a long-established fungicide used against Oomycetes in the cultivation of potatoes and vegetables. The compound II in which X is fluorine, 3-(4-fluorophenyl)-3-(3,4-dimethoxyphenyl)-1-morpholin-4-ylpropenone (IIb), is, under the common name “flumorph”, likewise known (EP-A 860 438). Compounds IIa and IIb are present as E,Z isomer mixtures.

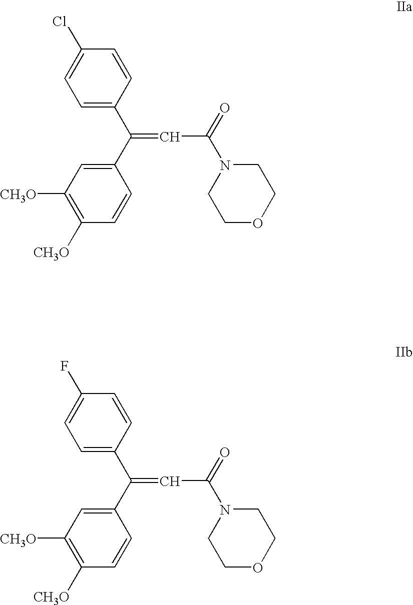

Mixtures of triazolopyrimidine derivatives with dimethomorph are known in a general manner from EP-A 988 790. The compound I is embraced by the general disclosure of this publication, but not explicitly mentioned. Accordingly, the combination of compound I with the compounds II is novel.

The synergistic mixtures known from EP-A 988 790 are described as being fungicidally active against various diseases of cereal, fruit and vegetable, in particular mildew on wheat and barley or gray mold on apples.

Owing to the special cultivation conditions of rice plants, the requirements that a rice fungicide has to meet are considerably different than those that fungicides used in cereal or fruit growing have to meet. There are significant differences in the application method: in rice crops, the fungicide is usually applied directly onto the soil during or shortly after sowing. The fungicide is taken up into the plant via the roots and transported in the sap of the plant to the plant parts to be protected. For rice fungicides, high systemic action is therefore essential. In contrast, in cereal or fruit growing, the fungicide is usually applied onto the leaves or the fruits; accordingly, in these crops the systemic action of the active compounds is considerably less important.

Moreover, rice pathogens are typically different from those in cereal or fruit. Pyricularia oryzae and Corticium sasakii (syn. Rhizoctonia solani) are the pathogens of the diseases most prevalent in rice plants. Rhizoctonia solani is the only pathogen of agricultural significance from the sub-class Agaricomycetidae. In contrast to most other fungi, this fungus attacks the plants not via spores but via a mycelium infection.

For these reasons, findings concerning the fungicidal activity of active compounds in the cultivation of cereals or fruit cannot be transferred to rice crops.

It was an object of the present invention to provide, with a view to an effective control of rice pathogens at application rates which are as low as possible, mixtures which, at a reduced total amount of active compounds, have improved action against the harmful fungi.

We have found that this object is achieved by the mixtures defined at the outset. Surprisingly, it has been found that the mixtures defined at the outset allow considerably better control of rice pathogens than the dimethomorph mixtures disclosed in EP-A 988 790. Moreover, we have found that simultaneous, that is joint or separate, application of the compounds I and the compounds II or successive application of the compounds I and the compounds II allows better control of rice pathogens than is possible with the individual compounds.

When preparing the mixtures, it is preferred to employ the pure active compounds I and IIa or IIb, to which further active compounds against harmful fungi or other pests, such as insects, arachnids or nematodes, or else herbicidal or growth-regulating active compounds or fertilizers can be added.

Further suitable active compounds in the above sense are, in particular, fungicides selected from the following group:
acylalanines, such as benalaxyl, metalaxyl, ofurace or oxadixyl,
amine derivatives, such as aldimorph, dodine, dodemorph, fenpropimorph, fenpropidin, guazatine, iminoctadine, spiroxamine or tridemorph,
anilinopyrimidines, such as pyrimethanil, mepanipyrim or cyprodinyl,
antibiotics, such as cycloheximide, griseofulvin, kasugamycin, natamycin, polyoxin or streptomycin,
azoles, such as bitertanol, bromoconazole, cyproconazole, difenoconazole, dinitroconazole, epoxiconazole, fenbuconazole, fluquiconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizole or triticonazole,
dicarboximides, such as iprodione, myclozolin, procymidone or vinclozolin,
dithiocarbamates, such as ferbam, nabam, maneb, mancozeb, metam, metiram, propineb, polycarbamate, thiram, ziram or zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, KIF 230, mepronil, nuarimol, picobenzamid, probenazole, proquinazid, pyrifenox, pyroquilon, quinoxyfen, silthiofam, thiabendazole, thifluzamide, thiophanate-methyl, tiadinil, tricyclazole or triforine,
copper fungicides, such as Bordeaux mixture, copper oxychloride, copper hydroxide, copper oxide, (basic) copper sulfate, copper oxychloride sulfate,
nitrophenyl derivatives, such as binapacryl, dinocap, dinobuton or nitrophthalisopropyl,
phenylpyrroles, such as fenpiclonil or fludioxonil,
sulfur,
other fungicides, such as acibenzolar-S-methyl, benthiavalicarb, carpropamid, chlorothalonil, cyflufenamid, cymoxanil, dazomet, diclomezine, diclocymet, diethofencarb, edifenphos, ethaboxam, fenhexamid, fentin acetate, fenoxanil, ferimzone, fluazinam, fosetyl, fosetyl-aluminum, iprovalicarb, hexachlorobenzene, metrafenone, pencycuron, propamocarb, phthalide, tolclofos-methyl, quintozene or zoxamide,
strobilurins, such as azoxystrobin, dimoxystrobin, fluoxastrobin, kresoxim-methyl, metominostrobin, orysastrobin, picoxystrobin, pyraclostrobin or trifloxystrobin,
sulfenic acid derivatives, such as captafol, captan, dichlofluanid, folpet or tolylfluanid,
cinnamides and analogous compounds, such as flumetover.

In one embodiment of the mixtures according to the invention, the compounds I and II are admixed with a further fungicide III or two fungicides III and IV.

Suitable components III and, if appropriate, IV from this list are in particular the strobilurins, dithiocarbamates, copper fungicides and the other fungicides mentioned.

Preference is given to mixtures of the compounds I and II with one component III.

Particular preference is given to mixtures of the compounds I and II.

Especially preferred are mixtures of the compound I with dimethomorph (IIa).

The mixtures of compounds I and IIa or IIb, or the compounds I and IIa or IIb used simultaneously, that is jointly or separately, exhibit outstanding action against rice pathogens from the classes of the Ascomycetes, Deuteromycetes and Basidiomycetes. They have high systemic action and can therefore be used for the treatment of seed and as foliar- and soil-acting fungicides.

They are especially important for controlling harmful fungi on rice plants and their seeds, such as Bipolaris and Drechslera species, and also Pyricularia oryzae. They are particularly suitable for controlling rice blast caused by Pyricularia oryzae.

In addition, the combination according to the invention of the compounds I and II is also suitable for controlling other pathogens, such as, for example, Septoria and Puccinia species in cereals and Alternaria and Boytritis species in vegetables, fruit and grapevine.

The compounds I and the compounds IIa or IIb can be applied simultaneously, that is jointly or separately, or in succession, the sequence, in the case of separate application, generally not having any effect on the result of the control measures.

The compound I and the compounds II are usually applied in a weight ratio of from 100:1 to 1:100, preferably from 20:1 to 1:20, in particular from 10:1 to 1:10.

The components III and, if appropriate, IV are, if desired, mixed with the compound I in a ratio of from 20:1 to 1:20.

Depending on the desired effect, the application rates of the mixtures according to the invention are from 5 g/ha to 1500 g/ha, preferably from 50 to 1000 g/ha, in particular from 50 to 750 g/ha.

Correspondingly, the application rates of the compound I are generally from 1 to 1000 g/ha, preferably from 10 to 750 g/ha, in particular from 20 to 500 g/ha.

Correspondingly, the application rates of the compound II are generally from 1 to 1000 g/ha, preferably from 10 to 750 g/ha, in particular from 20 to 500 g/ha.

In the treatment of seed, the application rates of the mixture are generally from 1 to 1000 g/100 kg of seed, preferably from 1 to 200 g/100 kg, in particular from 5 to 100 g/100 kg.

In the control of harmful fungi which are pathogenic to rice plants, the separate or joint application of the compounds I and II or of the mixtures of the compounds I and II is carried out by spraying or dusting the seeds, the seedlings, the plants or the soils before or after sowing of the plants or before or after emergence of the plants. The compounds are preferably applied jointly or separately, preferably by applying granules or by dusting the soils.

The mixtures according to the invention or the compounds I and II can be converted into the customary formulations, for example solutions, emulsions, suspensions, dusts, powders, pastes and granules. The application form depends on the particular purpose; in each case, it should ensure a fine and uniform distribution of the compound according to the invention.

The formulations are prepared in a known manner, for example by extending the active compound with solvents and/or carriers, if desired using emulsifiers and dispersants. Solvents/auxiliaries which are suitable are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.
carriers such as ground natural minerals (for example kaolins, clays, talc, chalk) and ground synthetic minerals (for example highly disperse silica, silicates); emulsifiers such as nonionic and anionic emulsifiers (for example polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The following are examples of formulations: 1. Products for dilution with water

A) Soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifier (Ultraturax) and made into a homogeneous emulsion. Dilution with water gives an emulsion.

E) Suspensions (SC, OD)

In an agitated ball mill, 20 parts by weight of the active compounds are comminuted with addition of dispersants, wetters and water or an organic solvent to give a fine active compound suspension. Dilution with water gives a stable suspension of the active compound.

F) Water-Dispersible Granules and Water-Soluble Granules (WG, SG)

50 parts by weight of the active compounds are ground finely with addition of dispersants and wetters and made into water-dispersible or water-soluble granules by means of technical appliances (for example extrusion, spray tower, fluidized bed). Dilution with water gives a stable dispersion or solution of the active compound.

G) Water-Dispersible Powders and Water-Soluble Powders (WP, SP)

75 parts by weight of the active compounds are ground in a rotor-stator mill with addition of dispersants, wetters and silica gel. Dilution with water gives a stable dispersion or solution of the active compound.

2. Products to be Applied Neat

H) Dustable Powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and associated with 95.5% carriers. Current methods are extrusion, spray-drying or the fluidized bed. This gives granules to be applied neat.

J) ULV Solutions (UL)

10 parts by weight of the active compounds are dissolved in an organic solvent, for example xylene. This gives a product to be applied neat.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; it is intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Various types of oils, wetters, adjuvants, herbicides, fungicides, other pesticides, or bactericides may be added to the active compounds, if appropriate just immediately prior to use (tank mix). These agents can be admixed to the agents according to the invention, usually done in a weight ratio from 1:10 to 10:1.

The compounds I and II or the mixtures or the corresponding formulations are applied by treating the harmful fungi or the plants, seeds, soils, areas, materials or spaces to be kept free from them with a fungicidally effective amount of the mixture or, in the case of separate application, of the compounds I and II. Application can be carried out before or after infection by the harmful fungi.

The fungicidal action of the compound and the mixtures can be demonstrated by the experiments below:

The active compounds, separately or jointly, were prepared as a stock solution with 0.25% by weight of active compound in acetone or DMSO. 1% by weight of the emulsifier Uniperol® EL (wetting agent having emulsifying and dispersing action based on ethoxylated alkylphenols) was added to this solution, and the solution was diluted with water to the desired concentration.

Use Example—Protective Activity Against Rice Blast Caused by Pyricularia oryzae

Leaves of rice seedlings of the cultivar “Tai-Nong 67”, which had been grown in pots, were sprayed to runoff point with an aqueous suspension having the concentration of active compounds stated below. The next day, the plants were inoculated with an aqueous spore suspension of Pyricularia oryzae. The test plants were then placed in climatized chambers at 22-24° C. and 95-99% relative atmospheric humidity for 6 days. The extent of the development of the infection on the leaves was then determined visually.

Evaluation was carried out by determining the infected leaf areas in percent. These percentages were converted into efficacies.

The efficacy (E) is calculated as follows using Abbot's formula:
E=(1−α/β)·100
α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of the mixtures of active compounds are determined using Colby's formula [R. S. Colby, Weeds 15, 20-22 (1967)] and compared with the observed efficacies.

Colby's Formula:
E=x+y−x·y/100
E expected efficacy, expressed in % of the untreated control, when using the mixture of the active compounds A and B at the concentrations a and b
x efficacy, expressed in % of the untreated control, when using active compound A at the concentration a
y efficacy, expressed in % of the untreated control, when using active compound B at the concentration b

The comparative compounds used were compounds A and B, known from the dimethomorph mixtures described in EP-A 988 790:

TABLE A

| | |
|---|---|
| | A |
| 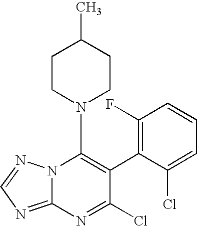 | |
| | B |
| 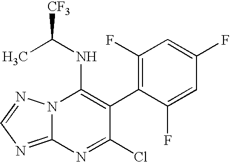 | |

Individual active compounds

| | | Concentration of | |
|---|---|---|---|
| | | active | Efficacy in % |
| | | compound in the | of the untreated |
| Example | Active compound | spray liquor [ppm] | control |
| 1 | control (untreated) | — | (90% infection) |
| 2 | I | 1 | 11 |
| 3 | IIa (dimethomorph) | 4 | 0 |
| | | 0.25 | 0 |
| 4 | IIb (flumorph) | 4 | 0 |
| 0.25 | 0 | | |
| 5 | Comparative | 1 | 11 |
| | compound A | | |
| 6 | Comparative | 1 | 22 |
| | compound B | | |

TABLE B
Mixtures according to the invention

| | Mixture of active compounds; | | Calculated |
|---|---|---|---|
| Example | concentration; mixing ratio | Observed efficacy | efficacy*) |
| 7 | I + IIa | 78 | 11 |
| | 1 + 4 ppm | | |
| | 1:4 | | |
| 8 | I + IIa | 56 | 11 |
| | 1 + 0.25 ppm | | |
| | 4:1 | | |
| 9 | I + IIb | 56 | 11 |
| | 1 + 4 ppm | | |
| | 1:4 | | |
| 10 | I + IIb | 44 | 11 |
| | 1 + 0.25 ppm | | |
| | 4:1 | | |

*)efficacy calculated using Colby's formula

TABLE C
Comparative experiments - mixtures known from EP-A 988 780

| | Mixture of active compounds; | | Calculated |
|---|---|---|---|
| Example | concentration; mixing ratio | Observed efficacy | efficacy*) |
| 11 | A + IIa | 0 | 11 |
| | 1 + 4 ppm | | |
| | 1:4 | | |
| 12 | A + IIa | 11 | 11 |
| | 1 + 0.25 ppm | | |
| | 4:1 | | |
| 13 | B + IIa | 33 | 22 |
| | 1 + 4 ppm | | |
| | 1:4 | | |
| 14 | B + IIa | 22 | 22 |
| | 1 + 0.25 ppm | | |
| | 4:1 | | |

*)efficacy calculated using Colby's formula

The test results show that the mixtures according to the invention have, owing to strong synergism, considerably better activity against rice blast than the dimethomorph mixtures known from EP-A 988 780, although the comparative compounds as individual active compounds have an activity better than or comparable to that of compound I.

1. A fungicidal mixture for controlling rice pathogens, comprising
1) the triazolopyrimidine derivative of the formula, 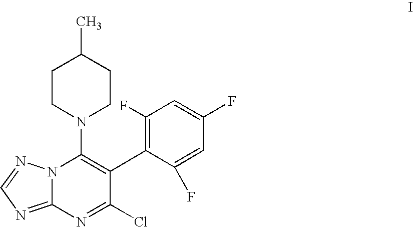
and
2) an acryloylmorpholide of the formula II, 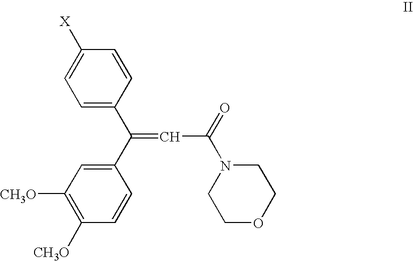
in which X is chlorine or fluorine,
in a synergistically effective amount.

2. A fungicidal mixture comprising the compound of the formula I and the compounds of the formula II in a weight ratio of from 100:1 to 1:100.

3. A fungicidal mixture comprising, as acryloylmorpholide, dimethomorph of the formula IIa

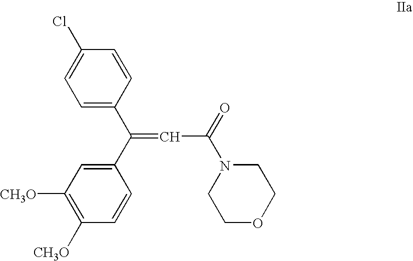

4. A fungicidal composition comprising a liquid or solid carrier and a mixture as claimed in claim 1.

5. A method for controlling harmful fungi which are rice pathogens, which comprises treating the fungi, their habitat or the plants, the soil or the seeds to be protected against fungal attack with an effective amount of the compound I and one of the compounds II as set forth in claim 1.

6. A method as claimed in claim 5, wherein the compounds I and II as set forth in claim 1 are applied simultaneously, that is jointly or separately, or in succession.

7. A method as claimed in claim 5, wherein the mixture is applied in an amount of from 5 g/ha to 1500 g/ha.

8. A method as claimed in claim 5 or 6, wherein the mixture is applied in an amount of from 1 to 1000 g/100 kg of seed.

9. A method as claimed in claim 5, wherein the harmful fungus Pyricularia oryzae is controlled.

10. Seed, comprising the mixture as claimed in claim 1, in an amount of from 1 to 1000 g/100 kg.

11. The use of the compound I and the compound II as set forth in claim 1 for preparing a composition suitable for controlling harmful fungi.
